(19) United States
(12) Patent Application Publication
(10) Pub. No.: US 2024/0114532 A1
(43) Pub. Date: Apr. 4, 2024

(54) WIRELESS COMMUNICATION ENABLED SMART DEVICE AND METHODS OF USE THEREOF

(71) Applicant: Opal Wearables, Inc., Brooklyn, NY (US)

(72) Inventors: Han Hua Jennifer Chiang, New York, NY (US); Lance Norman, Jersey City, NJ (US)

(73) Assignee: Opal Wearables, Inc., Brooklyn, NY (US)

(21) Appl. No.: 18/365,717

(22) Filed: Aug. 4, 2023

Related U.S. Application Data
(60) Provisional application No. 63/474,944, filed on Sep. 29, 2022.

(51) Int. Cl. H04W 72/30; H04W 64/00; H04W 76/50

(52) U.S. Cl. CPC H04W 72/30; H04W 64/003; H04W 76/50

(57) ABSTRACT

The present disclosure provides a smart device configured to periodically transmit, via a wireless communication radio, a wireless advertisement comprising a wireless advertisement frame carrying data that identifies the wearable device. The smart device detects an actuation of a physical trigger associated with the wearable device. The smart device automatically generates an interrupt configured to cause the wireless communication radio to cease periodically transmitting the wireless advertisement. The smart device generates emergency alert packet carrying emergency alert data indicative of an occurrence of an emergency based on the actuation of the physical trigger, and transmits broadcast signal carrying the emergency alert packet, wherein the wireless communication radio is configured to retransmit the broadcast signal a plurality of times at decreasing intervals between each time of the plurality of times.

### CROSS-REFERENCE TO RELATED APPLICATIONS

The present application claims priority to and the benefit of U.S. Provisional Patent Application No. 63/474,944, filed Sep. 29, 2022, and entitled “Bluetooth enabled smart ring containing input sensor, capable of contacting authorities in case of an emergency,” the entirety of which is herein incorporated by reference.

### FIELD OF TECHNOLOGY

The present disclosure generally relates to systems, devices and/or components configured for a wireless communication enabled smart device, and in particular a smart device configured to transmit, upon user actuation of a tactile trigger, wireless communication signals to control a primary device to issue an emergency alert.

### BACKGROUND OF TECHNOLOGY

Wearable devices can be designed to help users, such as seniors and people with disabilities, summon help in case of an emergency. These devices can have features like global position system (GPS), cellular connectivity, fall detection, activity trackers, and health monitors. They can be either mobile or fixed in the home and can also connect with a smartphone app that allows caregivers and loved ones to check on the user.

### SUMMARY OF DESCRIBED SUBJECT MATTER

In some aspects, the techniques described herein relate to a method including: periodically transmitting, by at least one wireless communication radio of a smart device, a wireless advertisement including a wireless advertisement frame carrying data that identifies the smart device; detecting, by the smart device, an actuation of a tactile trigger associated with the smart device; automatically generating, by the smart device, an interrupt configured to cause the at least one wireless communication radio to cease periodically transmitting the wireless advertisement; generating, by the smart device, at least one emergency alert packet carrying emergency alert data indicative of an occurrence of an emergency based on the actuation of the tactile trigger; and transmitting, by the at least one wireless communication radio, at least one broadcast signal carrying the at least one emergency alert packet, wherein the at least one wireless communication radio is configured to retransmit the at least one broadcast signal a plurality of times at decreasing intervals between each time of the plurality of times.

In some aspects, the techniques described herein relate to a method, wherein the at least one emergency alert packet is configured to cause a primary device to generate an emergency response request to an emergency response service, the emergency response request including data representing at least one of: a current global positioning system (GPS) location of the primary device, or an altitude of the primary device.

In some aspects, the techniques described herein relate to a method, wherein the wireless advertisement includes a wireless communication signal based on at least one of: Bluetooth, Bluetooth Low Energy, Radio frequency identification (RFID), or Near Field Communication (NFC).

In some aspects, the techniques described herein relate to a method, further including: receiving, by the smart device, at least one check-in signal carrying at least one check-in request; and controlling, by the smart device, at least one component to emit a perceptible notification to a user associated with the smart device, the perceptible notification including at least one of an audible notification, or a haptic notification.

In some aspects, the techniques described herein relate to a method, further including: determining, by the smart device, a lack of a response user input via the tactile trigger within a predetermined period of time of emitting the perceptible notification; and automatically generating, by the smart device, the interrupt.

In some aspects, the techniques described herein relate to a method, further including: determining, by the smart device, a response user input via the tactile trigger within a predetermined period of time of emitting the perceptible notification; and controlling, by the smart device, the at least one wireless communication radio to continue to periodically transmit the wireless advertisement.

In some aspects, the techniques described herein relate to a method, further including: detecting, by the smart device, a pattern of actuation of the tactile trigger, the pattern being associated with a particular emergency contact of at least one emergency contact; and generating, by the smart device, the at least one emergency alert packet carrying the emergency alert data indicative of the duration of actuation of the tactile trigger.

In some aspects, the techniques described herein relate to a device including: at least one processing device configured to: periodically transmit, via at least one wireless communication radio, a wireless advertisement including a wireless advertisement frame carrying data that identifies the smart device; detect—an actuation of a tractile trigger associated with the smart device; automatically generate an interrupt configured to cause the at least one wireless communication radio to cease periodically transmitting the wireless advertisement; generate at least one emergency alert packet carrying emergency alert data indicative of an occurrence of an emergency based on the actuation of the tactile trigger; and transmit, via the at least one wireless communication radio, at least one broadcast signal carrying the at least one emergency alert packet, wherein the at least one wireless communication radio is configured to retransmit the at least one broadcast signal a plurality of times at decreasing intervals between each time of the plurality of times.

In some aspects, the techniques described herein relate to a device, wherein the at least one emergency alert packet is configured to cause a primary device to generate an emergency response depending on the packet configuration, which may be either a notification or alarm triggered on a secondary device, or a request to an emergency response service or predefined emergency contacts, the emergency response request including data representing at least one of: a current global positioning system (GPS) location of the primary device, or an altitude of the primary device.

In some aspects, the techniques described herein relate to a device, wherein the wireless advertisement includes a wireless communication signal based on at least one of: Bluetooth, Bluetooth Low Energy, Radio frequency identification (RFID), or Near Field Communication (NFC).

In some aspects, the techniques described herein relate to a device, wherein the at least one processing device is further configured to: receive at least one check-in signal carrying at least one check-in request; and control at least one component to emit a perceptible notification to a user associated with the smart device, the perceptible notification including at least one of an audible notification, or a haptic notification.

In some aspects, the techniques described herein relate to a device, wherein the at least one processing device is further configured to: determine a lack of a response user input via the tactile trigger within a predetermined period of time of emitting the perceptible notification; and automatically generate the interrupt.

In some aspects, the techniques described herein relate to a device, wherein the at least one processing device is further configured to: determine a response from user input via the tactile trigger within a predetermined period of time of emitting the perceptible notification; which may include multiple tactile trigger presses and or duration of tactile press to encode the desired mode of emergency dispatch, and control at least one wireless communication radio to continue to periodically transmit the wireless advertisement containing the sequence and or duration of the tactile trigger.

In some aspects, the techniques described herein relate to a device, wherein the at least one processing device is further configured to: detect a pattern of actuation of the tactile trigger, the pattern being associated with a particular emergency contact of at least one emergency contact; and generate the at least one emergency alert packet carrying the emergency alert data indicative of the duration of actuation of the tactile trigger.

In some aspects, the techniques described herein relate to a non-transitory computer readable medium having software instructions stored thereon, the software instructions configured to cause at least one processor device to perform steps including: periodically transmitting, via at least one wireless communication radio of a smart device, a wireless advertisement including a wireless advertisement frame carrying data that identifies the smart device; detecting, by the smart device, an actuation of a tractile trigger associated with the smart device; automatically generating, by the smart device, an interrupt configured to cause the at least one wireless communication radio to cease periodically transmitting the wireless advertisement; generating, by the smart device, at least one emergency alert packet carrying emergency alert data indicative of an occurrence of an emergency based on the actuation of the tactile trigger; and transmitting, by the at least one wireless communication radio, at least one broadcast signal carrying the at least one emergency alert packet, wherein the at least one wireless communication radio is configured to retransmit the at least one broadcast signal a plurality of times at decreasing intervals between each time of the plurality of times.

In some aspects, the techniques described herein relate to a non-transitory computer-readable medium, wherein the at least one emergency alert packet is configured to cause a primary device to generate an emergency response request to an emergency response service, the emergency response request including data representing at least one of: device user background information, a current global positioning system (GPS) location of the primary device, an altitude of the primary device, or an accurate timestamp of emergency request.

In some aspects, the techniques described herein relate to a non-transitory computer-readable medium, wherein the wireless advertisement includes a wireless communication signal based on at least one of: Bluetooth, Bluetooth Low Energy, Radio frequency identification (RFID), Long Range Wide Area Network (LoRaWAN), or Near Field Communication (NFC).

In some aspects, the techniques described herein relate to a non-transitory computer-readable medium, wherein the software instructions are further configured to cause at least one processor device to perform steps including: receiving, by the smart device, at least one check-in signal carrying at least one check-in request; and controlling, by the smart device, at least one component to emit a perceptible notification to a user associated with the smart device, the perceptible notification including at least one of an audible notification, or a haptic notification.

In some aspects, the techniques described herein relate to a non-transitory computer-readable medium, wherein the software instructions are further configured to cause at least one processor device to perform steps including: determining, by the smart device, a lack of a response user input via the tactile trigger within a predetermined period of time of emitting the perceptible notification; and automatically generating, by the smart device, the interrupt.

In some aspects, the techniques described herein relate to a non-transitory computer-readable medium, wherein the software instructions are further configured to cause at least one processor device to perform steps including: determining, by the smart device, a response from user input via the tactile trigger, which may include multiple tactile trigger presses and or duration of tactile press to encode the desired mode of emergency dispatch, within a predetermined period of time of emitting the perceptible notification; and controlling, by the smart device, the at least one wireless communication radio to continue to periodically transmit the wireless advertisement.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 depicts an emergency alert system utilizing a smart device 10 with a primary device 20 for generating emergency alerts in accordance with one or more embodiments of the present disclosure.

FIG. 2 depicts a smart device 10 and a primary device 20 for generating emergency alerts in accordance with one or more embodiments of the present disclosure.

FIG. 3 depicts a block diagram of another exemplary computer-based system and platform for an emergency alert system in accordance with one or more embodiments of the present disclosure.

FIG. 4 depicts illustrative schematics of an exemplary implementation of the cloud computing/architecture(s) in which embodiments of a system for an emergency alert system may be specifically configured to operate in accordance with some embodiments of the present disclosure.

FIG. 5 depicts illustrative schematics of another exemplary implementation of the cloud computing/architecture(s) in which embodiments of a system for an emergency alert system may be specifically configured to operate in accordance with some embodiments of the present disclosure.

FIG. 6 depicts a flowchart illustrating a method for emergency alerts utilizing a smart device with a primary device in accordance with one or more embodiments of the present disclosure.

### DETAILED DESCRIPTION

Various detailed embodiments of the present disclosure, taken in conjunction with the accompanying FIGURES, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or”, or with the conjunction “and.” In either case, the set is to be interpreted as meaning each of the items singularly as alternatives, as well as any combination of the listed items.

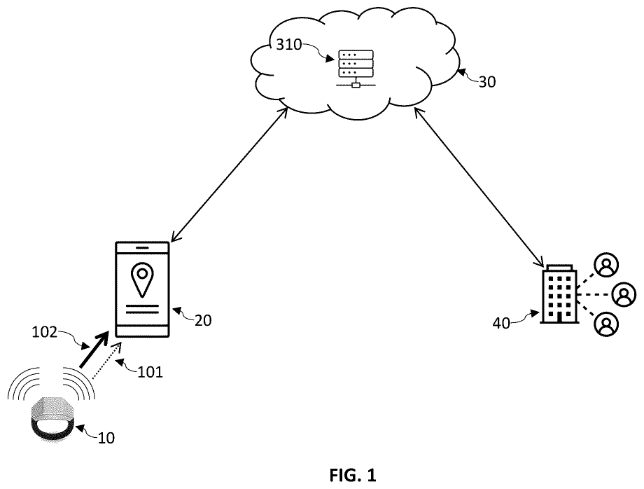

FIGS. 1 through 6 illustrate systems and methods of emergency detection and alerting using a wireless communication enabled smart device. The following embodiments provide technical solutions and technical improvements that overcome technical problems, drawbacks and/or deficiencies in the technical fields involving inter-device communication and wearable devices that typically include large, bulky devices requiring complex sensors and circuitry, such as GPS, Wi-Fi, cellular connectivity, touch displays, etc. As explained in more detail, below, technical solutions and technical improvements herein include aspects of improved wireless enabled smart devices and operation thereof that leverages a customized communication technology to enable low-power, efficient, and easy to use communication signals for issuing an emergency alert upon detection of an emergency. Based on such technical features, further technical benefits become available to users and operators of these systems and methods. Moreover, various practical applications of the disclosed technology are also described, which provide further practical benefits to users and operators that are also new and useful improvements in the art.

FIG. 1 depicts an emergency alert system utilizing a smart device 10 with a primary device 20 for generating emergency alerts in accordance with one or more embodiments of the present disclosure.

A user may encounter an emergency and have a need to communicate an alert to either another person or group, such as police, emergency medical services (EMS), the fire department, a care giver, an emergency contact 40, among others or any combination thereof, or to simply trigger an alarm/SOS siren on the user's smartphone, depending on the type of request send and user's individual configuration preferences. In some instances, the emergency may be such that there is a limited amount of time to issue the alert, or that discretion is necessary in issuing the alert. Thus, a discrete and/or aesthetically pleasing device may be configured for easy access and control to issue the alert in the event of an emergency. In some embodiments, such a device may include a wireless communication enabled smart device 10, such as, e.g., a wearable (smartwatch, smart jewelry, smart ring, smart clothing, smart glasses, etc.), a fob, wireless headphones, a smartphone, among other devices that may be kept on a person and accessed during an emergency, or any combination thereof. For example, the smart device 10 may take the form of a smart ring having a housing on a portion of the smart ring, the housing holding the circuitry of smart device 10, a tactile trigger, a radio and/or antenna, among other componentry or any combination thereof. The smart ring configuration may enable a user to actuate the tactile trigger with the same hand wearing the ring, thus enabling quick and easy actuation of the tactile trigger. Accordingly, users with impairments or in situations that restrict range of movement and/or the ability to use the opposite hand, may nevertheless actuate the tactile trigger to initiate an emergency alert.

In some embodiments, the term “smart device” may refer to an electronic device that has circuitry for implementing one or more software routines and is able to connect, share, and interact with its user and/or other devices. A smart device may connect to other devices or networks via different wireless protocols such as Bluetooth, Zigbee, near-field communication, Wi-Fi, LiFi, LoRa, or 5G and can operate to some extent interactively and autonomously.

In some embodiments, the smart device 10 may be configured to cooperate with a primary device 20 to send emergency alerts. In some embodiments, the primary device 20 may include a computing device or other computing resource configured to receive, directly or indirectly, wireless signals from the smart device 10. Based on the wireless signals, the primary device 20 may determine whether to issue an emergency alert and the data to be included in the emergency alert. In some embodiments, the primary device 20 may also communicate with the smart device 10 to provide settings, configurations, alerts and other signals or any combination thereof to control the smart device 10. Thus, the primary device 20 may be used as a primary device to a secondary device including the smart device 10 such that the primary device 20 and the smart device 10 have a primary-secondary relationship.

Thus, in some embodiments, the smart device 10 may leverage communication with the primary device 20 to reduce capabilities needed for the smart device 10, such as, e.g., communication with the network 30, complex processing, location determination, graphics rendering, among other tasks or any combination thereof may be offloaded to the primary device 10. As a result, the smart device 10 may include circuitry, such as one or more processing devices, for a particular set of software routines, and the ability to communicate with the primary device 20, thus reducing compute, power and storage resources needed by the smart device 10.

In some embodiments, the smart device 10 may include a radio for short range wireless communication, such as, e.g., Bluetooth, Zigbee, near-field communication, radio frequency identification (RFID), Wi-Fi, LiFi, Z-Wave, LoRa, among others or any combination thereof. The smart device 10 may be configured to communicate data to the primary device 20 where the data triggers the primary device 20 to transmit an emergency alert. For example, in some embodiments, upon detection of an emergency, the smart device 10 may send an alert packet 102 to the primary device 20.

In some embodiments, the alert packet 102 may be a transmission that include one or more data fields that are configured to signal the occurrence of an emergency for which an alert is to be sent. In some embodiments, the data field may be a binary variable, where a first value indicates an emergency, and a second value indicates not an emergency. In some embodiments, the alert packet 102 itself may signal the existence of an emergency, and thus the data field may be any value, a single value, a nonce, or other data or any combination thereof. As a result, the smart device 10 may be configured to send a preconfigured alert packet 102 upon detection of an emergency, reducing a need for more complex processing in structuring and/or generating the alert packet 102.

In some embodiments, the smart device 10 may detect an emergency based on a user input, e.g., via a tactile trigger. A tactile trigger may include a mechanism for signaling, in the circuitry of the smart device 10, an event associated with an emergency, where the mechanism includes hardware that a user can manipulate and/or actuate to trigger the signaling of the event. For example, the tactile trigger can include a physical button, a physical switch, a resistive touch element, a capacitive touch element, an accelerometer, a gyroscope, or other mechanism configured to detect the manipulation and/or actuation by the user.

In some embodiments, upon the user input via the tactile trigger, the smart device 10 may automatically emit a signal carrying the alert packet 102 via wireless communication. In some embodiments, the primary device 20 may be configured to receive the signal and extract the alert packet 102. In some embodiments, the signal may be a broadcast to any electronic device within range of the radio of the smart device 10, or may be a communication across a channel and/or session between the smart device 10 and primary device 20, e.g., via wireless pairing such as in Bluetooth or Wi-Fi pairing.

In some embodiments, the smart device 10 may periodically and/or continuously broadcast a beacon 101. The beacon 101 provides regular pings to the primary device 20. Because the smart device 10 uses short range wireless communication (e.g., as opposed to cellular or other longer-than-Wi-Fi range wireless technology), the pings can serve to notify the primary device 20 that the smart device 10 is within range, and thus nearby. The beacon 101 may also include the current battery state-of-charge at some interval to signal to the user if device 10 needs to be charged. Moreover, the pings provide “check-ins” that the smart device 10 is operational. As a result, the smart device 10 can ping the primary device 20 using lower power and compute resources than a persistent or active connection while enabling the primary device 20 to track the status and proximity of the smart device 10.

In some embodiments, the smart device 10 may emit the beacon 101 on a regular interval, such as, e.g., every second, two seconds, three seconds, four seconds, five seconds, six seconds, eight seconds, nine seconds, ten seconds, fifteen seconds, twenty seconds, thirty seconds, forty five seconds, 60 seconds, two minutes, three minutes, four minutes, five minutes, ten minutes, or more or any other value in a range of 1/10 th of a second to thirty minutes.

In some embodiments, the use actuating the tactile trigger may cause the smart device 10 to interrupt the regular beacons 101 to generate and emit the alert packet 102. In some embodiments, the primary device 20 may have a software application configured to initiate an alert in response to receiving the alert packet 102 and/or in response to not receiving a beacon 101 in a given period. Alternatively, or additionally, the primary device 20 may initiate an audible alarm or siren depending on the type of emergency request contained within the alert packet 102.

In some embodiments, to initiate the alert, the software application may be configured to extract and analyze the alert packet 102 when available. In some embodiments, the software application may include instructions that correlate the data of the alert packet 102 to the existence of an emergency, a type of emergency, a time or an emergency, a severity of an emergency, among other attributes of an emergency. In some embodiments, where the alert is initiated based on not receiving the beacon 101 in the given period, attributes such as time and location of the emergency are inferred to be the location associated with the last received beacon 101 and the time of receiving the last received beacon 101. In some embodiments, the time and location may be any time and location between the last received beacon 101 and the given period at the which the next beacon 101 was expected but not received. In some embodiments, the software application may include instructions that correlate the data of the alert packet 102 to the routine monitoring of the device 10 battery health.

Based on the attributes, the software application may identify an emergency contact 40, such as police, emergency medical services (EMS), the fire department, a care giver, an emergency contact 40, among others or any combination thereof. For example, a user may specify in the software application a default emergency contact 40 in the event of emergency. Alternatively or in addition, different emergency types may be directed to different emergency contacts 40, for example a fall or injury may generate an alert to EMS and/or a caregiver, an attack by person or animal may generate an alert to police, a medical event such as a seizure or allergic reaction may generate an event to EMS, a caregiver or a specified person, among other emergency types and/or emergency contacts 40, or any combination thereof.

In some embodiments, the software application may determine a destination associated with the emergency contact 40. The destination may include a network address (e.g., a server 31) on the network 30, a device identifier associated with the emergency contact 40, one or more computer interface technologies associated with a software service of the emergency contact 40, an email address, a telephone number, among other addressing and/or interfacing techniques or any combination thereof.

In some embodiments, the server 31 should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples. In some embodiments, the terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user). The aforementioned examples are, of course, illustrative and not restrictive. In some embodiments, the server 31 may route the emergency alert to the emergency contact, e.g., via one or more computer interface technologies.

In some embodiments, one or more computer interface technologies used by the software application of the primary device 20 and/or by the server 31 may include, without limitation, Common Object Request Broker Architecture (CORBA), an application programming interface (API) and/or application binary interface (ABI), among others or any combination thereof. In some embodiments, an API and/or ABI defines the kinds of calls or requests that can be made, how to make the calls, the data formats that should be used, the conventions to follow, among other requirements and constraints. An “application programming interface” or “API” can be entirely custom, specific to a component, or designed based on an industry-standard to ensure interoperability to enable modular programming through information hiding, allowing users to use the interface independently of the implementation. In some embodiments, CORBA may normalize the method-call semantics between application objects residing either in the same address-space (application) or in remote address-spaces (same host, or remote host on a network).

In some embodiments, the network 30 may include any suitable computer network, including, two or more computers that are connected with one another for the purpose of communicating data electronically. In some embodiments, the network may include a suitable network type, such as, e.g., a public switched telephone network (PTSN), an integrated services digital network (ISDN), a private branch exchange (PBX), a wireless and/or cellular telephone network, a computer network including a local-area network (LAN), a wide-area network (WAN) or other suitable computer network, or any other suitable network or any combination thereof. In some embodiments, a LAN may connect computers and peripheral devices in a physical area by means of links (wires, Ethernet cables, fiber optics, wireless such as Wi-Fi, etc.) that transmit data. In some embodiments, a LAN may include two or more personal computers, printers, and high-capacity disk-storage devices, file servers, or other devices or any combination thereof. LAN operating system software, which interprets input and instructs networked devices, may enable communication between devices to: share the printers and storage equipment, simultaneously access centrally located processors, data, or programs (instruction sets), and other functionalities. Devices on a LAN may also access other LANs or connect to one or more WANs. In some embodiments, a WAN may connect computers and smaller networks to larger networks over greater geographic areas. A WAN may link the computers by means of cables, optical fibers, or satellites, cellular data networks, or other wide-area connection means. In some embodiments, an example of a WAN may include the Internet.

In some embodiments, the emergency alert may include alert data and/or alert content data. In some embodiments, the emergency alert may include alert data and content data representing emergency related information. In some embodiments, the alert data may include source data associated with a source of the emergency alert, destination data associated with a destination of each emergency alert, a date, a time, a data size, among other related data and metadata for each emergency alert.

In some embodiments, the alert data may include the source data regarding a sender and/or sending computing device, e.g., the primary device 20 and/or the smart device 10. For example, source data may include, e.g., a computing device type (e.g., smart device, smartphone, tablet, laptop computer, smartwatch, or other computing device), sender data such as a sender identifier (e.g., email address, host server address, user account, name, company or organization name, etc.), among other data and combinations thereof. In some embodiments, the source data may identify an individual, particular device, and/or location associated with an emergency of the emergency alert. Thus, the emergency alert may identify to the emergency contact 40 where and/or to whom the emergency is occurring.

In some embodiments, the alert data may include the destination data regarding a recipient and/or receiving computing device such as the emergency contact 40. For example, destination data may include, e.g., a computing device type (e.g., smartphone, tablet, laptop computer, smartwatch, or other computing device), recipient data such as a recipient identifier (e.g., email address, host server address, user account, name, company or organization name, etc.), among other data and combinations thereof.

In some embodiments, the content data may include data and metadata representing the content of the emergency alert. In some embodiments, the emergency alert may include text content, images (e.g., JPG, EXIF, TIFF, BMP, WebP, GIF, HEIF, PNG, etc.), formatting of text and/or images, interactive media (e.g., videos formatted as, e.g., MP4, MOV, WMV, FLY, AVI, AVCHD, WebM, MKV, VP9, etc.), Javascript or other software script elements, Emoji, hyperlinks, attached documents (such as documents provided in a formation including, e.g., PDF, DOC, DOCX, XLS, XLSX, PPT, PPTX, ODF, HTML/CSS, XML, etc.) among other message contents or any combination thereof. In some embodiments, the content data may include data representing the content as well as formatting, layout, size, or other content metadata or any combination thereof.

In some embodiments, the content data may represent attributes of the emergency alert, such as a location of detection of the emergency, emergency type, time of detection of the emergency, username, user address, among other data characterizing the nature of the emergency based on the alert packet 102 or any combination thereof. Accordingly, the emergency contact 40 may relay the emergency alert, e.g., by dispatching police officers, an ambulance, a fire engine, or other emergency response resource, or by contacting and/or traveling to the user associated with the emergency. In some embodiments, the content data may include instructions to and/or directions to the location of the emergency based on the location of the primary device 20 at the time of detection of the emergency via user actuation of the tactile trigger of the smart device 10.

Accordingly, a user may alert one or more emergency contacts and receive support and/or assistance in response simply by employing the tactile trigger of the smart device 10.

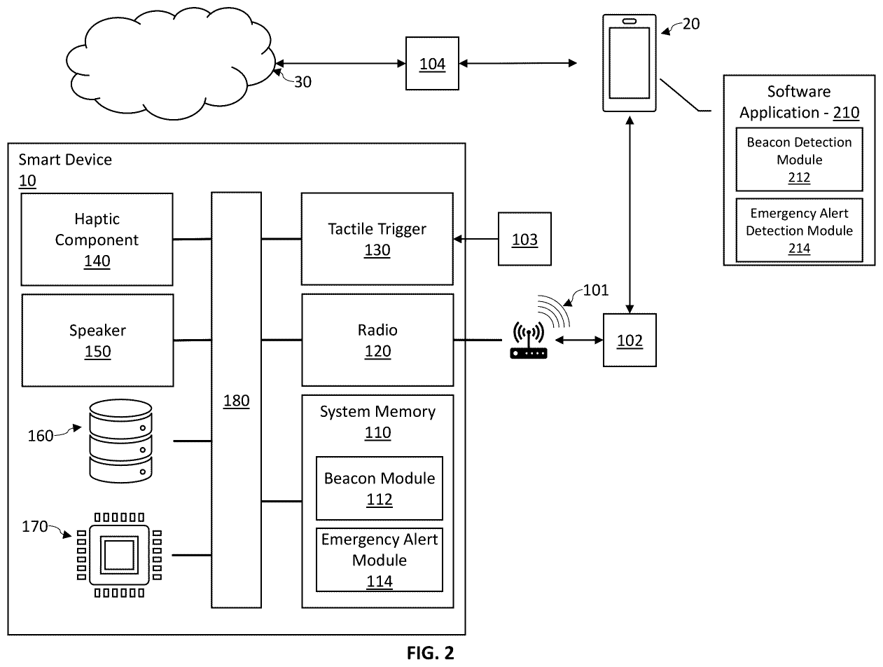

FIG. 2 depicts a smart device 10 and a primary device 20 for generating emergency alerts in accordance with one or more embodiments of the present disclosure.

In some embodiments, the smart device 10 may include hardware and/or software components configured to generate the beacons 101 and/or alert packet 102 based on user input 103. In some embodiments, the hardware and/or software components may include a system memory 110 storing software routines such as a beacon module 112 and emergency alert module 114, a radio 120, a tactile trigger 130, a haptic component 140, a speaker 150, one or more data stores 160, one or more processing devices 170, among other hardware and/or software componentry or any combination thereof. In some embodiments, the various components may be configured to interconnect via a data bus 180 so as to enable software instructions to control the operation of any one or more of the hardware and/or software components of the smart device 10.

Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

In some embodiments, the processing device 170 may include any type of data processing capacity, such as a hardware logic circuit, for example an application specific integrated circuit (ASIC) and a programmable logic, or such as a computing device, for example, a microcomputer or microcontroller that include a programmable microprocessor. In some embodiments, the processing device 170 may include data-processing capacity provided by the microprocessor. In some embodiments, the microprocessor may include memory, processing, interface resources, controllers, and counters. In some embodiments, the microprocessor may also include one or more programs stored in memory. If an embodiment uses a hardware logic circuit, the logic circuit generally includes a logical structure that operates one or more of the other hardware and/or software components.

In some embodiments, the data bus 180 may include any suitable communication system that transfers data between components inside the smart device 10, include an internal data bus, memory bus, system bus, address bus, front-side bus, or other internal bus or any combination thereof. In some embodiments, examples of the bus may include, e.g., PCI express, small computer system interface (SCSI), parallel AT attachment (PATA), serial AT attachment (SATA), HyperTransport™, InfiniBand™, Wishbone, Compute Express Link (CXL), among others or any combination thereof.

In some embodiments, the data storage 160 may include, e.g., a suitable memory or storage solutions for maintaining electronic data associated with the smart device 10 and/or the hardware and/or software components, such as bootloader and/or firmware software and/or configurations, a log of device status (e.g., battery state of charge, transmission and receiving signals including times thereof, etc.), a universally unique identifier (UUID), media access control (MAC) address, among other data or any combination thereof. For example, the data storage 160 may include database technology such as, e.g., a centralized or distributed database, cloud storage platform, decentralized system, server or server system, among other storage systems. In some embodiments, the data storage 160 may, additionally or alternatively, include one or more data storage devices such as, e.g., a hard drive, solid-state drive, flash memory, or other suitable storage device. In some embodiments, the data storage 160 may, additionally or alternatively, include one or more temporary storage devices such as, e.g., a random-access memory, cache, buffer, or other suitable memory device, or any other data storage solution and combinations thereof.

In some embodiments, during operation, the processing device 170 may execute instructions of the beacon module 112 to interact with the radio 120 to generate the periodic and/or continuous beacons 101. In some embodiments, the beacon module 112 may include one or more software routines stored in the system memory 110, where the software routine(s) define the parameters of the beacons 101. The parameters may include the ping interval on which the beacons 101 are emitted, the duration of each beacon 101, the data carried by each beacon 101, among other parameters or any combination thereof. For example, in some embodiments, the beacons 101 may conform to the iBeacon protocol. Accordingly, the software routine(s) of the beacon module 112 may be configured to structure of each advertisement, including each advertisement frame, to include a prefix representative of the iBeacon protocol, a universally unique identifier (UUID) associated with the smart device 10, and a major-minor pair. In some embodiments, the advertisement may also or alternatively include, e.g., a current batter state of charge, a battery status (e.g., low battery, high battery or anything in between), a bit or flag indicative of a non-emergency advertisement, among other data or any combination thereof. The iBeacon protocol provides one-way transmissions of the advertisement frames where the prefix ensures that only a particular application, including the software application 210 of the primary device 20, may receive and/or decode the advertisement frame. As a result, the beacons 101 provide regular pings via the advertisement frames that alert the primary device 20 to the presence and continued operation of the smart device 10. In some embodiments, the primary device 20 may also or alternatively determine a proximity of the smart device 10 based on the beacons 101, such as a near, mid and/or far proximity, or other characterization of an estimated distance between the smart device 10 and the primary device 20. In some embodiments, the proximity may be determined based on, e.g., received signal strength indicator (RSSI) or other technique.

In some embodiments, the beacon module 112 interact with the radio 120 to generate the beacons 101 according to any suitable beacon protocol, including, without limitation, iBeacon, Eddystone, AltBeacon, GeoBeacon, among others or any combination thereof. In some embodiments, the beacon module 112 may generate the beacons 101 using one or more wireless communication technologies, including, without limitation, Bluetooth, Bluetooth Low Energy (BLE), Wi-Fi, Wi-Fi direct, Wi-Fi aware, ultrasound, LiFi, Z-Wave, ZigBee, Matter, LoRa, NFC, RFID, among others or any combination thereof. Accordingly, instead of typical active session communications, such as generic attribute (GATT) Bluetooth connections, the smart device 10 may intermittently transmit beacons 101 with lower power use and lower bandwidth use than typical GATT communications while still notifying the primary device 20 of the presence and/or proximity of the smart device 10 and the operation thereof.

In some embodiments, the primary device 20 may be configured to run the software application 210 constantly in the background (e.g., to reduce power consumption) to regularly check for the beacons 101 from the smart device 10. For example, the software application 210 may include a beacon detection module 212 configured to interact with communication componentry of the primary device 20 to check, on dedicated clock cycles specific to the software application 210, for reception of a beacon 101. In some embodiments, the beacons 101 may be emitted on constant time intervals, such as, e.g., one per every 5, 6, 7, 8, 9, 10, 11, 12, 13, 14, 15, 16, 17, 18, 19, 20, 25, 30 or more seconds, or one every time period where the time period is selected from a range of values between about 2 seconds and about 2 minutes. In some embodiments, the decreasing time intervals ensures that even where one or more beacons 101 are received at the primary device 20 on clock cycle(s) for which the beacon detection module 212 is not configured to check, a later beacon 101 is received at the primary device 20 on a clock cycle for which the software application 210 performs a check. In some embodiments, the decreasing time intervals may cycle, such that upon a minimum time interval being reached for a given beacon 101, a next beacon 101 is issued at a maximum time interval, with further subsequent beacons 101 emitted at on the decreasing time intervals starting with the maximum time interval.

In some embodiments, periodically, automatically and/or where the beacons 101 are not received at the configured time interval by the primary device 20, the software application 210 of the primary device 20 may be configured to initiate a check-in feature. In some embodiments, the check-in feature may include generating a check-in request that is designed to elicit a response from the user to check in on the user's well-being. In some embodiments, upon generating the check-in request, the primary device 20 may issue a check-in signal carrying the check-in request to the smart device 10. The smart device 10 may receive the check-in signal via the radio 120, causing the processor device 170 to receive the check-in request.

In some embodiments, in response to the check-in request, the processing device 170 may automatically generate a check-in notification to the user via one or more of the speaker 150 and/or the haptic component 140. In some embodiments, the check-in notification may include a perceptible notification to the user. The perceptible notification may include an audible notification, such as a tone, chime, alarm, prerecorded voice message (e.g., stored in the data store 160), or other audible alert via the speaker 150. In some embodiments, the perceptible notification may include a haptic notification, such as a vibration or pattern of vibrations emitted from the haptic component 140. In some embodiments, the perceptible notification may include a combination of audible and haptic notifications.

In some embodiments, the processing device 170 may control the speaker 150 and/or the haptic component 140 to persist and/or repeat the perceptible notification until the user provides a response user input indicating the user's well-being. In some embodiments, the response user input may include the user input 103 via the tactile trigger 130, and/or may include one or more requirements for the user input, such as, e.g., a specific duration of holding the button/switch/capacitive surface/resistive surface/etc., a number of repeated actuations of the tactile trigger 130, a frequency of repeated actuations, among others or any combination thereof. In some embodiments, the check-in notification may be interactive such that upon the response user input, the check-in notification repeats and/or generates a subsequent perceptible notification one or more times to ensure an accidental or false response user input is avoided. In some embodiments, features of a pattern of the user input 103 such as the duration, the frequency of actuations, the number of actuations, among other features of the pattern may be mapped to particular functions and/or emergency-related data, such as particular emergency contacts to contact for an emergency response request, a mode of issuing the emergency response request (e.g., Internet communication, SMS, audible output, Bluetooth broadcast, Wi-Fi broadcast, smart home device notification, among others or nay combination thereof), additional functions of the smart device 10 to perform (e.g., haptic feedback via the haptic component 140, audible feedback via the speaker 150 such as a confirmation tone, an emergency alarm noise, etc.), additional functions of the primary device 20 to perform (e.g., audible alarm or SOS siren, haptic feedback via vibration, a type of emergency occurring, among other functions and/or emergency-related data or any combination thereof.

In some embodiments, the smart device 10 may receive the user input 103 via the tactile trigger 130. The tactile trigger 130 may include a mechanism for signaling, in the circuitry of the smart device 10, an event associated with an emergency, where the mechanism includes hardware that a user can manipulate and/or actuate to trigger the signaling of the event. For example, the tactile trigger can include a physical button, a physical switch, a resistive touch element, a capacitive touch element, an accelerometer, a gyroscope, or other mechanism configured to detect the manipulation and/or actuation by the user. For example, the user input 103 may be a press of a physical button or switch, or a tap on an outer housing of the smart device 10 that an accelerometer of the tactile trigger 130 is configured to detect as the user input 103, a gesture detected by a gyroscope and/or accelerometer, a tap, swipe or other contact with a resistive and/or capacitive outer surface, or any other suitable actuation or any combination thereof.

In some embodiments, the tactile trigger 130 may be configured to detect predetermined intentional user inputs 103 such as a tap, gesture or other, as well as or instead a movement pattern indicative of an emergency. For example, the tactile trigger 130 may include firmware or other software configured to interpret accelerometer and/or gyroscope measurements as a movement pattern indicative of a fall. In some embodiments, the detection of the user inputs 103 may include detecting for how long the tactile trigger 130 is in a state of actuation (e.g., how long the button is being held in a pressed position, etc.). In some embodiments, the duration may indicate a desired emergency contact, such as, e.g., a first duration being associated with 9-1-1, and a second duration being associated with contacting a predefined individual, among other emergency contacts or any combination, each emergency contact being mapped to a particular duration of actuation.

In some embodiments, the user inputs 103 via the tactile trigger 130 may include one or more alternative or additional features or any combination thereof to form of a pattern of the user input 103. In some embodiments, such features may include, without limitation, the duration of each actuation, the frequency of actuations, the number of actuations, among other features or any combination thereof. In some embodiments, the pattern may be mapped to particular functions and/or emergency-related data, such as a particular emergency contact or group of emergency contacts to contact for an emergency response request, a mode of issuing the emergency response request (e.g., Internet communication, SMS, audible output, Bluetooth broadcast, Wi-Fi broadcast, smart home device notification, among others or nay combination thereof), additional functions of the smart device 10 to perform (e.g., haptic feedback via the haptic component 140, audible feedback via the speaker 150 such as a confirmation tone, an emergency alarm noise, etc.), additional functions of the primary device 20 to perform (e.g., audible alarm or SOS siren, haptic feedback via vibration, a type of emergency occurring, among other functions and/or emergency-related data or any combination thereof.

In some embodiments, as a result of the user input 103, non-reception of a beacon 101 at an expected interval and/or lack of response user input within a predetermined interval in response to the check-in request, the processing device 170 may detect an event indicative of an emergency. In some embodiments, the predetermined interval may be, e.g., 5, 6, 7, 8, 9, 10, 11, 12, 13, 14, 15, 16, 17, 18, 19, 20, 25, 30, 35, 40, 45, 50, 55, 60 or more seconds, or any other time selected from a range of values between about 2 seconds and about 5 minutes. In some embodiments, where there is lack of response user input within the predetermined interval, the software application 210 may issue a follow-up check-in request having a follow-up predetermined interval in which the user is to provide the response user input, where the follow-up predetermined interval is less than the predetermined interval.

In some embodiments, based on the event, the processing device 170 may interrupt the software routine(s) of the beacon module 112 and initiate the emergency alert module 114. In some embodiments, the emergency alert module 114 may generate an alert packet 102, e.g., as a chirp broadcast to nearby devices including the primary device 20. In some embodiments, the chirp may be a different broadcast from the beacons 101, e.g., a broadcast signal carrying additional data, such as, e.g., a time, a duration of actuation of the tactile trigger 130, a battery state of charge or other device status, time of a received check-in request (if applicable), among other data. In some embodiments, the chirp may be a modified beacon 101 where a flag indicating non-emergency is modified to indicate an emergency (e.g., termed a “bit flip”). In some embodiments, in executing the software routine(s) of the emergency alert module 114, the processing device 170 may employ the radio 120 to generate one or more of the chirps to transmit the alert packet 102, where the one or more chirps may be emitted once or more than once, e.g., on an interval, such as a periodic interval, a decreasing time interval, or by any other timing.

In some embodiments, the primary device 20 may be configured to run the software application 210 constantly in the background (e.g., to reduce power consumption) to regularly check for the alert packet 102 of a chirp from the smart device 10. For example, the software application 210 may include an emergency alert detection module 214 configured to interact with communication componentry of the primary device 20 to check, on dedicated clock cycles specific to the software application 210, for reception of an alert packet 102. In some embodiments, the alert packet 102 may be emitted multiple times on constant time intervals that decreased relative to the beacons 101 to increase a likelihood that the software application 210 detects the alert packet 102 during a sooner clock cycle to which the software application 210 is scheduled for operation processing on a processor of the primary device 20. In some embodiments, the constant time interval may include any suitable time interval, such as, e.g., one per every 1, 2, 3, 4, 5, 6, 7, 8, 9, 10, 11, 12, 13, 14, 15, 16, 17, 18, 19, 20, 25, 30 or more seconds, or one every time period where the time period is selected from a range of values between about 0.1 seconds and about 2 minutes.

In some embodiments, the decreasing time intervals ensures that even where one or more alert packets 102 are received at the primary device 20 on clock cycle(s) for which the emergency alert detection module 214 is not configured to check, a later alert packet 102 is received at the primary device 20 on a clock cycle for which the software application 210 performs a check. In some embodiments, the decreasing time intervals may cycle, such that upon a minimum time interval being reached for a given alert packet 102, a next alert packet 102 is issued at a maximum time interval, with further subsequent alert packet 102 emitted at on the decreasing time intervals starting with the maximum time interval. This design enables immediate and accurate reception of the alert packet 102, enabling prompt dispatch of emergency alerts 104.

In some embodiments, upon detection of the alert packet 102, the primary device 20 may determine emergency-related data based on one or more components and/or sensors of the primary device 20. For example, in some embodiments, the primary device 20 may determine a current GPS location using a GPS radio, a current altitude based one or more barometric pressure sensors, one or more previous or recent GPS locations, a current time, a time of the alert packet 102, user-related data including a name, address, picture, government issued ID number, address, among others or any combination thereof.

In some embodiments, the primary device 20 may then generate an emergency alert 104 to an associated emergency contact, e.g., via the network 30. In some embodiments, the software application 210 may determine, based on the emergency-related data and based on user configuration, an associated emergency contact to which to send an emergency response request. For example, the duration of actuation of the tactile trigger 130 may be used to determine an emergency contact indicated by the duration. In some embodiments, as detailed above, the emergency contact may include, without limitation, police, EMS, the fire department, a caregiver, an individual, among others or any combination thereof. In some embodiments, the emergency alert 104 may include emergency-related data, such as, e.g., the existence of an emergency, a type of emergency, a time or an emergency, a severity of an emergency, a name of the user associated with the smart device 10, an address of the user, an emergency contact or next of kin, a healthcare provider associated with the user, a caregiver associated with the user, a user identifier such as an account number or government issued ID or both, photographic of the user, the UUID of the smart device 10, among other attributes or any combination thereof. In some embodiments, the emergency related data may be determined by the primary device 20, e.g., based on location determination and stored data of the primary device, or may be extracted from the alert packet 102, or any combination thereof.

In some embodiments, the emergency contact may include an interactive service accessible via the network 30, e.g., via an API, ABI, CORBA, etc. Thus, the emergency contact may return a confirmation to the primary device 20 via the network 30 in response to the emergency alert 104.

In some embodiments, in addition to the emergency alert request, the primary device 20 may control a speaker of the primary device 20 and/or emit a signal to the smart device 10 to control the speaker 150 to generate and emit an audible siren, e.g., to warn or deter an attacker, alert nearby people to the emergency for assistance, among other purposes or any combination thereof.

In some embodiments, additionally or alternatively, the smart device 10 may be used to trigger an audible and/or tactile alarm by the primary device 20, such as, e.g., an audible siren. For example, in the case of a perceived threat, e.g., by another person or animal, or to alert others nearby to a need for immediate assistance, the user may provide a user input 103 configured to produce an alert packet 102 that causes the primary device to emit the audible siren from a speaker thereof. In some embodiments, the audible siren may be triggered upon the user actuating the tactile trigger 130 with a press, or with a pattern of presses. For example, as detailed above, the pattern formed by duration of each press, frequency of presses, number of presses among others or any combination thereof, may be mapped to the audible siren or a particular audible siren from a set of siren types. The set of siren types can include a siren associated with imminent danger, a siren associated with an attack by another, among other sirens characterized by volume, tone, duration, among other features of audible playback.

In some embodiments, in response to the confirmation returned by the emergency contact, the software application 210 of the primary device 20 may be configured to transmit a response to the smart device 10 confirming the notification of the emergency contact. As a result, the radio 120 of the smart device 10 may receive the response from the primary device 20 and automatically cause the processing device 170 to trigger a perceptible notification to the user. The perceptible notification may include an audible notification, such as a tone, chime, alarm, prerecorded voice message (e.g., stored in the data store 160), or other audible alert via the speaker 150. In some embodiments, the perceptible notification may include a haptic notification, such as a vibration or pattern of vibrations emitted from the haptic component 140. In some embodiments, the perceptible notification may include a combination of audible and haptic notifications. As a result of the confirmation and perceptible notification, the call-back from the emergency contact, such as call back from 9-1-1, may be bypassed. Indeed, the user may provide a subsequent user input 103 to confirm the receipt of the perceptible notification, the subsequent user input 103 being configured to cause the radio 120 to emit a subsequent alert packet 102 that is configured to cause the software application 210 to issue a confirmation to the emergency contact, obviating the need for a call back.

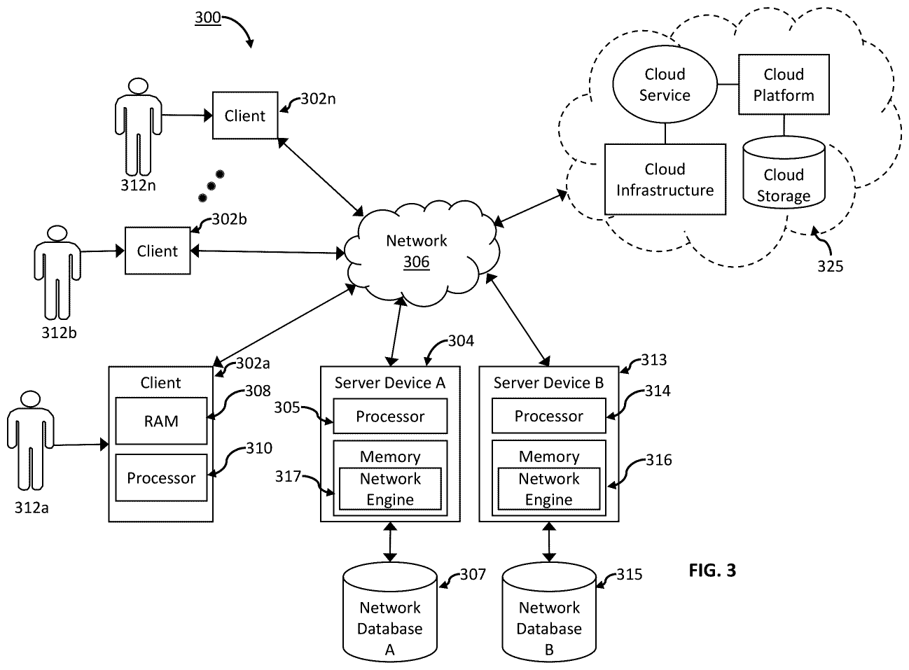

FIG. 3 depicts a block diagram of another exemplary computer-based system and platform 300 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the client device 302a, client device 302b through client device 302n shown each at least includes a computer-readable medium, such as a random-access memory (RAM) 308 coupled to a processor 310 or FLASH memory. In some embodiments, the processor 310 may execute computer-executable program instructions stored in memory 308. In some embodiments, the processor 310 may include a microprocessor, an ASIC, and/or a state machine. In some embodiments, the processor 310 may include, or may be in communication with, media, for example computer-readable media, which stores instructions that, when executed by the processor 310, may cause the processor 310 to perform one or more steps described herein. In some embodiments, examples of computer-readable media may include, but are not limited to, an electronic, optical, magnetic, or other storage or transmission device capable of providing a processor, such as the processor 310 of client device 302a, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc.

In some embodiments, client devices 302a through 302n may also comprise a number of external or internal devices such as a mouse, a CD-ROM, DVD, a physical or virtual keyboard, a display, or other input or output devices. In some embodiments, examples of client devices 302a through 302n (e.g., clients) may be any type of processor-based platforms that are connected to a network 306 such as, without limitation, personal computers, digital assistants, personal digital assistants, smart phones, pagers, digital tablets, laptop computers, Internet appliances, and other processor-based devices. In some embodiments, client devices 302a through 302n may be specifically programmed with one or more application programs in accordance with one or more principles/methodologies detailed herein. In some embodiments, client devices 302a through 302n may operate on any operating system capable of supporting a browser or browser-enabled application, such as Microsoft™, Windows™, and/or Linux. In some embodiments, client devices 302a through 302n shown may include, for example, personal computers executing a browser application program such as Microsoft Corporation's Internet Explorer™, Apple Computer, Inc.'s Safari™, Mozilla Firefox, and/or Opera. In some embodiments, through the member computing client devices 302a through 302n, user 312a, user 312b through user 312n, may communicate over the exemplary network 306 with each other and/or with other systems and/or devices coupled to the network 306. As shown in FIG. 3, exemplary server devices 304 and 313 may include processor 305 and processor 314, respectively, as well as memory 317 and memory 316, respectively. In some embodiments, the server devices 304 and 313 may be also coupled to the network 306. In some embodiments, one or more client devices 302a through 302n may be mobile clients.

In some embodiments, at least one database of exemplary databases 307 and 315 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

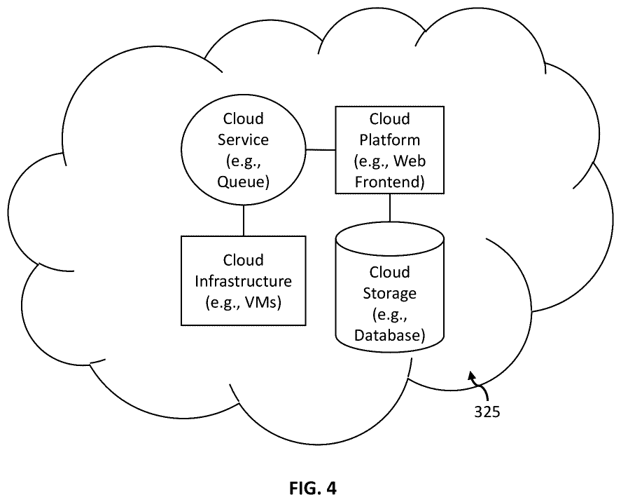

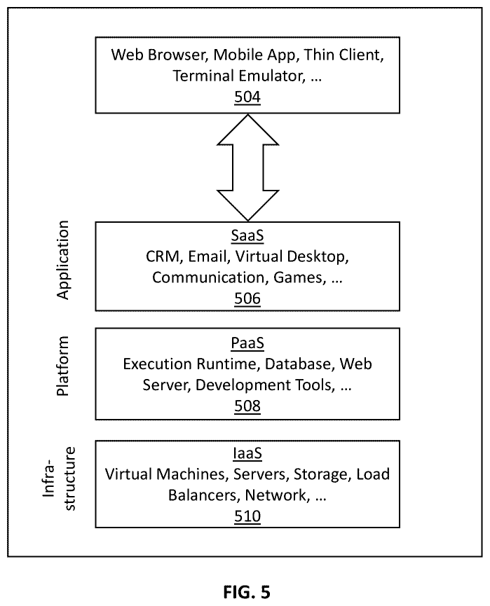

In some embodiments, the exemplary inventive computer-based systems/platforms, the exemplary inventive computer-based devices, and/or the exemplary inventive computer-based components of the present disclosure may be specifically configured to operate in a cloud computing/architecture 325 such as, but not limiting to: infrastructure a service (IaaS) 510, platform as a service (PaaS) 508, and/or software as a service (SaaS) 506 using a web browser, mobile app, thin client, terminal emulator or other endpoint 504. FIGS. 4 and 5 illustrate schematics of exemplary implementations of the cloud computing/architecture(s) in which the exemplary inventive computer-based systems/platforms, the exemplary inventive computer-based devices, and/or the exemplary inventive computer-based components of the present disclosure may be specifically configured to operate.

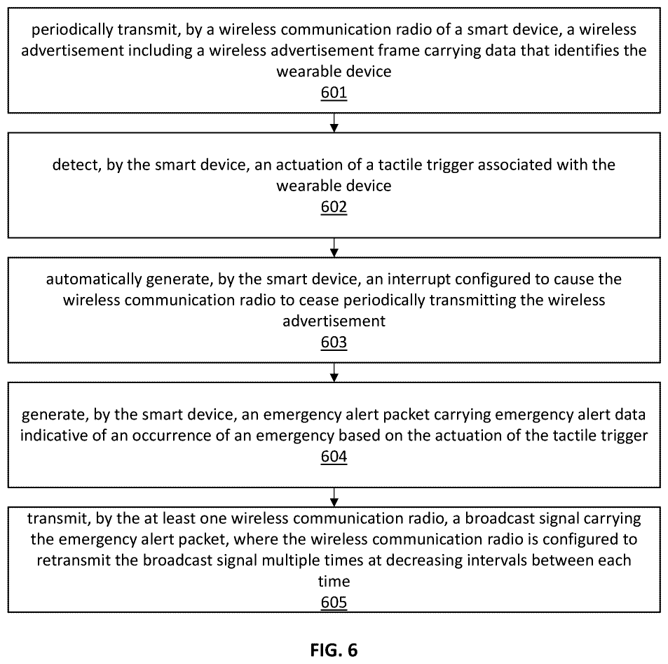

FIG. 6 depicts a flowchart illustrating a method for emergency alerts utilizing a smart device with a primary device in accordance with one or more embodiments of the present disclosure.

At step 601, the smart device controls a wireless communication radio to periodically transmit advertisements. In some embodiments, the wireless advertisement may include a wireless advertisement frame carrying data that identifies the smart device.

At step 602, the smart device detects an actuation of a tactile trigger associated with the smart device.

At step 603, the smart device automatically generates an interrupt configured to cause the wireless communication radio to cease periodically transmitting the wireless advertisement.

At step 604, the smart device generates an emergency alert packet carrying emergency alert data indicative of an occurrence of an emergency based on the actuation of the tactile trigger.

At step 605, the smart device controls a wireless communication radio to transmit the broadcast signal carrying the emergency alert packet. In some embodiments, the wireless communication radio is configured to retransmit the broadcast signal multiple times at decreasing intervals between each time.

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a user interacting with an application on a mobile device) occurs, in order that results of the computation can be used in guiding the physical process.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, several hours, daily, several days, weekly, monthly, etc.

As used herein, the term “runtime” corresponds to any behavior that is dynamically determined during an execution of a software application or at least a portion of a software application.

In some embodiments, exemplary inventive, specially programmed computing systems and platforms with associated devices are configured to operate in the distributed network environment, communicating with one another over one or more suitable data communication networks (e.g., the Internet, satellite, etc.) and utilizing one or more suitable data communication protocols/modes such as, without limitation, IPX/SPX, X.25, AX.25, AppleTalk™, TCP/IP (e.g., HTTP), near-field wireless communication (NFC), RFID, Narrow Band Internet of Things (NBIOT), 3G, 4G, 5G, GSM, GPRS, WiFi, WiMax, CDMA, satellite, ZigBee, and other suitable communication modes.

In some embodiments, the NFC can represent a short-range wireless communications technology in which NFC-enabled devices are “swiped,” “bumped,” “tap” or otherwise moved in close proximity to communicate. In some embodiments, the NFC could include a set of short-range wireless technologies, typically requiring a distance of 10 cm or less. In some embodiments, the NFC may operate at 13.56 MHz on ISO/IEC 18000-3 air interface and at rates ranging from 106 kbit/s to 424 kbit/s. In some embodiments, the NFC can involve an initiator and a target; the initiator actively generates an RF field that can power a passive target. In some embodiments, this can enable NFC targets to take very simple form factors such as tags, stickers, key fobs, or cards that do not require batteries. In some embodiments, the NFC's peer-to-peer communication can be conducted when a plurality of NFC-enabled devices (e.g., smartphones) are within close proximity of each other.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of illustrative computer-based systems or platforms of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

As used herein, term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

In some embodiments, as detailed herein, one or more of the computer-based systems of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a message, a map, an entire application (e.g., a calculator), data points, and other suitable data. In some embodiments, as detailed herein, one or more of the computer-based systems of the present disclosure may be implemented across one or more of various computer platforms such as, but not limited to: (1) FreeBSD, NetBSD, OpenBSD; (2) Linux; (3) Microsoft Windows™; (4) OpenVMS™; (5) OS X (MacOS™); (6) UNIX™; (7) Android; (8) iOS™; (9) Embedded Linux; (10) Tizen™; (11) WebOS™; (12) Adobe AIR™; (13) Binary Runtime Environment for Wireless (BREW™); (14) Cocoa™ (API); (15) Cocoa™ Touch; (16) Java™ Platforms; (17) JavaFX™; (18) QNX™; (19) Mono; (20) Google Blink; (21) Apple WebKit; (22) Mozilla Gecko™; (23) Mozilla XUL; (24) .NET Framework; (25) Silverlight™; (26) Open Web Platform; (27) Oracle Database; (28) Qt™; (29) SAP NetWeaver™; (30) Smartface™; (31) Vexi™; (32) Kubernetes™ and (33) Windows Runtime (WinRT™) or other suitable computer platforms or any combination thereof. In some embodiments, illustrative computer-based systems or platforms of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

In some embodiments, illustrative computer-based systems or platforms of the present disclosure may be configured to handle numerous concurrent users that may be, but is not limited to, at least 100 (e.g., but not limited to, 100-999), at least 1,000 (e.g., but not limited to, 1,000-9,999), at least 10,000 (e.g., but not limited to, 10,000-99,999), at least 100,000 (e.g., but not limited to, 100,000-999,999), at least 1,000,000 (e.g., but not limited to, 1,000,000-9,999,999), at least 10,000,000 (e.g., but not limited to, 10,000,000-99,999,999), at least 100,000,000 (e.g., but not limited to, 100,000,000-999,999,999), at least 1,000,000,000 (e.g., but not limited to, 1,000,000,000-999,999,999,999), and so on.

In some embodiments, illustrative computer-based systems or platforms of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, or objects. For example, such projections may be a visual overlay for a mobile augmented reality (MAR) application.

In some embodiments, illustrative computer-based systems or platforms of the present disclosure may be configured to be utilized in various applications which may include, but not limited to, gaming, mobile-device games, video chats, video conferences, live video streaming, video streaming and/or augmented reality applications, mobile-device messenger applications, and others similarly suitable computer-device applications.

As used herein, the term “mobile electronic device,” or the like, may refer to any portable electronic device that may or may not be enabled with location tracking functionality (e.g., MAC address, Internet Protocol (IP) address, or the like). For example, a mobile electronic device can include, but is not limited to, a mobile phone, Personal Digital Assistant (PDA), Blackberry™, Pager, Smartphone, or any other reasonable mobile electronic device.

As used herein, terms “proximity detection,” “locating,” “location data,” “location information,” and “location tracking” refer to any form of location tracking technology or locating method that can be used to provide a location of, for example, a particular computing device, system or platform of the present disclosure and any associated computing devices, based at least in part on one or more of the following techniques and devices, without limitation: accelerometer(s), gyroscope(s), Global Positioning Systems (GPS); GPS accessed using Bluetooth™; GPS accessed using any reasonable form of wireless and non-wireless communication; WiFi™ server location data; Bluetooth™ based location data; triangulation such as, but not limited to, network based triangulation, WiFi™ server information based triangulation, Bluetooth™ server information based triangulation; Cell Identification based triangulation, Enhanced Cell Identification based triangulation, Uplink-Time difference of arrival (U-TDOA) based triangulation, Time of arrival (TOA) based triangulation, Angle of arrival (AOA) based triangulation; techniques and systems using a geographic coordinate system such as, but not limited to, longitudinal and latitudinal based, geodesic height based, Cartesian coordinates based; Radio Frequency Identification such as, but not limited to, Long range RFID, Short range RFID; using any form of RFID tag such as, but not limited to active RFID tags, passive RFID tags, battery assisted passive RFID tags; or any other reasonable way to determine location. For ease, at times the above variations are not listed or are only partially listed; this is in no way meant to be a limitation.

As used herein, terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user).

In some embodiments, the illustrative computer-based systems or platforms of the present disclosure may be configured to securely store and/or transmit data by utilizing one or more of encryption techniques (e.g., private/public key pair, Triple Data Encryption Standard (3DES), block cipher algorithms (e.g., IDEA, RC2, RC5, CAST and Skipjack), cryptographic hash algorithms (e.g., MDS, RIPEMD-160, RTR0, SHA-1, SHA-2, Tiger (TTH), WHIRLPOOL, RNGs).

As used herein, the term “user” shall have a meaning of at least one user. In some embodiments, the terms “user”, “subscriber” “consumer” or “customer” should be understood to refer to a user of an application or applications as described herein and/or a consumer of data supplied by a data provider. By way of example, and not limitation, the terms “user” or “subscriber” can refer to a person who receives data provided by the data or service provider over the Internet in a browser session, or can refer to an automated software application which receives the data and stores or processes the data.

The aforementioned examples are, of course, illustrative and not restrictive.

At least some aspects of the present disclosure will now be described with reference to the following numbered clauses.

Clause 1. A method including: periodically transmitting, by at least one wireless communication radio of a smart device, a wireless advertisement including a wireless advertisement frame carrying data that identifies the smart device; detecting, by the smart device, an actuation of a tactile trigger associated with the smart device; automatically generating, by the smart device, an interrupt configured to cause the at least one wireless communication radio to cease periodically transmitting the wireless advertisement; generating, by the smart device, at least one emergency alert configuration packet carrying emergency alert data indicative of an occurrence of an emergency based on the actuation of the tactile trigger; and transmitting, by the at least one wireless communication radio, at least one broadcast signal carrying the at least one emergency alert packet, where the at least one wireless communication radio is configured to retransmit the at least one broadcast signal a plurality of times at decreasing intervals between each time of the plurality of times.

Clause 2. The method of clause 1, where the at least one emergency alert packet is configured to cause a primary device to generate an emergency response request to an emergency response service or a predefined emergency contact, the emergency response request including data representing at least one of: a current global positioning system (GPS) location of the primary device, or an altitude of the primary device, relevant user contact information.

Clause 3. The method of clause 1, where the wireless advertisement includes a wireless communication signal based on at least one of: Bluetooth, Bluetooth Low Energy, Radio frequency identification (RFID), or Near Field Communication (NFC).

Clause 4. The method of clause 1, further including: receiving, by the smart device, at least one check-in signal carrying at least one check-in request; and controlling, by the smart device, at least one component to emit a perceptible notification to a user associated with the smart device, the perceptible notification including at least one of an audible notification, or a haptic notification.

Clause 5. The method of clause 4, further including: determining, by the smart device, a lack of a response user input via the tactile trigger within a predetermined period of time of emitting the perceptible notification; and automatically generating, by the smart device, the interrupt.

Clause 6. The method of clause 4, further including: determining, by the smart device, a response user input via the tactile trigger within a predetermined period of time of emitting the perceptible notification; and controlling, by the smart device, the at least one wireless communication radio to continue to periodically transmit the wireless advertisement.

Clause 7. The method of clause 1, further including: detecting, by the smart device, a pattern of actuation of the tactile trigger, the pattern being associated with a particular emergency contact of at least one emergency contact; and generating, by the smart device, the at least one emergency alert packet carrying the emergency alert data indicative of the pattern of actuation of the tactile trigger.

Clause 8. A device including: at least one processing device configured to: periodically transmit, via at least one wireless communication radio, a wireless advertisement including a wireless advertisement frame carrying data that identifies the smart device; detect—an actuation of a tractile trigger associated with the smart device; automatically generate an interrupt configured to cause the at least one wireless communication radio to cease periodically transmitting the wireless advertisement; generate at least one emergency alert packet carrying emergency alert data indicative of an occurrence of an emergency based on the actuation of the tactile trigger; and transmit, via the at least one wireless communication radio, at least one broadcast signal carrying the at least one emergency alert packet, where the at least one wireless communication radio is configured to retransmit the at least one broadcast signal a plurality of times at decreasing intervals between each time of the plurality of times.

Clause 9. The device of clause 8, where the at least one emergency alert packet is configured to cause a primary device to generate an emergency response request to an emergency response service, the emergency response request including data representing at least one of: a current global positioning system (GPS) location of the primary device, or an altitude of the primary device.

Clause 10. The device of clause 8, where the wireless advertisement includes a wireless communication signal based on at least one of: Bluetooth, Bluetooth Low Energy, Radio frequency identification (RFID), or Near Field Communication (NFC).

Clause 11. The device of clause 8, where the at least one processing device is further configured to: receive at least one check-in signal carrying at least one check-in request; and control at least one component to emit a perceptible notification to a user associated with the smart device, the perceptible notification including at least one of an audible notification, or a haptic notification.

Clause 12. The device of clause 11, where the at least one processing device is further configured to: determine a lack of a response user input via the tactile trigger within a predetermined period of time of emitting the perceptible notification; and automatically generate the interrupt.

Clause 13. The device of clause 11, where the at least one processing device is further configured to: determine a response user input via the tactile trigger within a predetermined period of time of emitting the perceptible notification; and control the at least one wireless communication radio to continue to periodically transmit the wireless advertisement.

Clause 14. The device of clause 11, where the at least one processing device is further configured to: detect a pattern of actuation of the tactile trigger, the pattern being associated with a particular emergency contact of at least one emergency contact; and generate the at least one emergency alert packet carrying the emergency alert data indicative of the pattern of actuation of the tactile trigger.

Clause 15. A non-transitory computer readable medium having software instructions stored thereon, the software instructions configured to cause at least one processor device to perform steps including: periodically transmitting, via at least one wireless communication radio of a smart device, a wireless advertisement including a wireless advertisement frame carrying data that identifies the smart device; detecting, by the smart device, an actuation of a tractile trigger associated with the smart device; automatically generating, by the smart device, an interrupt configured to cause the at least one wireless communication radio to cease periodically transmitting the wireless advertisement; generating, by the smart device, at least one emergency alert packet carrying emergency alert data indicative of an occurrence of an emergency based on the actuation of the tactile trigger; and transmitting, by the at least one wireless communication radio, at least one broadcast signal carrying the at least one emergency alert packet, where the at least one wireless communication radio is configured to retransmit the at least one broadcast signal a plurality of times at decreasing intervals between each time of the plurality of times.

Clause 16. The non-transitory computer-readable medium of clause 15, where the at least one emergency alert packet is configured to cause a primary device to generate an emergency response request to an emergency response service, the emergency response request including data representing at least one of: a current global positioning system (GPS) location of the primary device, or an altitude of the primary device.

Clause 17. The non-transitory computer-readable medium of clause 15, where the wireless advertisement includes a wireless communication signal based on at least one of: Bluetooth, Bluetooth Low Energy, Radio frequency identification (RFID), or Near Field Communication (NFC).

Clause 18. The non-transitory computer-readable medium of clause 15, where the software instructions are further configured to cause at least one processor device to perform steps including: receiving, by the smart device, at least one check-in signal carrying at least one check-in request; and controlling, by the smart device, at least one component to emit a perceptible notification to a user associated with the smart device, the perceptible notification including at least one of an audible notification, or a haptic notification.

Clause 19. The non-transitory computer-readable medium of clause 18, where the software instructions are further configured to cause at least one processor device to perform steps including: determining, by the smart device, a lack of a response user input via the tactile trigger within a predetermined period of time of emitting the perceptible notification; and automatically generating, by the smart device, the interrupt.

Clause 20. The non-transitory computer-readable medium of clause 18, where the software instructions are further configured to cause at least one processor device to perform steps including: determining, by the smart device, a response user input via the tactile trigger within a predetermined period of time of emitting the perceptible notification; and controlling, by the smart device, the at least one wireless communication radio to continue to periodically transmit the wireless advertisement.

Publications cited throughout this document are hereby incorporated by reference in their entirety. While one or more embodiments of the present disclosure have been described, it is understood that these embodiments are illustrative only, and not restrictive, and that many modifications may become apparent to those of ordinary skill in the art, including that various embodiments of the inventive methodologies, the illustrative systems and platforms, and the illustrative devices described herein can be utilized in any combination with each other. Further still, the various steps may be carried out in any desired order (and any desired steps may be added and/or any desired steps may be eliminated).

What is claimed is:

1. A method comprising:
periodically transmitting, by at least one wireless communication radio of a smart device, a wireless advertisement comprising a wireless advertisement frame carrying data that identifies the smart device;
detecting, by the smart device, an actuation of a tactile trigger associated with the smart device;
automatically generating, by the smart device, an interrupt configured to cause the at least one wireless communication radio to cease periodically transmitting the wireless advertisement;
generating, by the smart device, at least one emergency alert packet carrying emergency alert data indicative of an occurrence of an emergency based on the actuation of the tactile trigger; and
transmitting, by the at least one wireless communication radio, at least one broadcast signal carrying the at least one emergency alert packet, wherein the at least one wireless communication radio is configured to retransmit the at least one broadcast signal a plurality of times at decreasing intervals between each time of the plurality of times.

2. The method of claim 1, wherein the at least one emergency alert packet is configured to cause a primary device, upon receiving the at least one broadcast signal, to perform at least one of:
generate an audible siren indicative of the occurrence of the emergency to alert others within audible range, or
generate an emergency response request to an emergency response service, the emergency response request comprising data representing at least one of:
a current global positioning system (GPS) location of the primary device, or
an altitude of the primary device.

3. The method of claim 1, wherein the wireless advertisement comprises a wireless communication signal based on at least one of:
Bluetooth,
Bluetooth Low Energy,
Radio frequency identification (RFID), or
Near Field Communication (NFC).

4. The method of claim 1, further comprising:
receiving, by the smart device, at least one check-in signal carrying at least one check-in request; and
controlling, by the smart device, at least one component to emit a perceptible notification to a user associated with the smart device, the perceptible notification comprising at least one of an audible notification, or a haptic notification.

5. The method of claim 4, further comprising:
determining, by the smart device, a lack of a response user input via the tactile trigger within a predetermined period of time of emitting the perceptible notification; and
automatically generating, by the smart device, the interrupt.

6. The method of claim 4, further comprising:
determining, by the smart device, a response user input via the tactile trigger within a predetermined period of time of emitting the perceptible notification; and
controlling, by the smart device, the at least one wireless communication radio to continue to periodically transmit the wireless advertisement.

7. The method of claim 1, further comprising:
detecting, by the smart device, a pattern of actuation of the tactile trigger, the pattern being associated with at least one particular emergency contact of at least one emergency contact; and
generating, by the smart device, the at least one emergency alert packet carrying the emergency alert data indicative of the pattern of actuation of the tactile trigger;
wherein the emergency alert data is configured to cause a primary device, upon receiving the at least one broadcast signal, to generate an emergency response request to the at least one particular emergency contact.

8. A device comprising:
at least one processing device configured to:
periodically transmit, via at least one wireless communication radio, a wireless advertisement comprising a wireless advertisement frame carrying data that identifies the device;
detect—an actuation of a tactile trigger associated with the device;
automatically generate an interrupt configured to cause the at least one wireless communication radio to cease periodically transmitting the wireless advertisement;
generate at least one emergency alert packet carrying emergency alert data indicative of an occurrence of an emergency based on the actuation of the tactile trigger; and
transmit, via the at least one wireless communication radio, at least one broadcast signal carrying the at least one emergency alert packet, wherein the at least one wireless communication radio is configured to retransmit the at least one broadcast signal a plurality of times at decreasing intervals between each time of the plurality of times.

9. The device of claim 8, wherein the at least one emergency alert packet is configured to cause a primary device, upon receiving the at least one broadcast signal, to perform at least one of:
generate an audible siren indicative of the occurrence of the emergency to alert others within audible range, or
generate an emergency response request to an emergency response service, the emergency response request comprising data representing at least one of:
a current global positioning system (GPS) location of the primary device, or
an altitude of the primary device.

10. The device of claim 8, wherein the wireless advertisement comprises a wireless communication signal based on at least one of:
Bluetooth,
Bluetooth Low Energy,
Radio frequency identification (RFID), or
Near Field Communication (NFC).

11. The device of claim 8, wherein the at least one processing device is further configured to:
receive at least one check-in signal carrying at least one check-in request; and
control at least one component to emit a perceptible notification to a user associated with the device, the perceptible notification comprising at least one of an audible notification, or a haptic notification.

12. The device of claim 11, wherein the at least one processing device is further configured to:
determine a lack of a response user input via the tactile trigger within a predetermined period of time of emitting the perceptible notification; and
automatically generate the interrupt.

13. The device of claim 11, wherein the at least one processing device is further configured to:
determine a response user input via the tactile trigger within a predetermined period of time of emitting the perceptible notification; and
control the at least one wireless communication radio to continue to periodically transmit the wireless advertisement.

14. The device of claim 11, wherein the at least one processing device is further configured to:
detect a pattern of actuation of the tactile trigger, the pattern being associated with at least one particular emergency contact of at least one emergency contact; and
generate the at least one emergency alert packet carrying the emergency alert data indicative of the pattern of actuation of the tactile trigger;
wherein the emergency alert data is configured to cause a primary device, upon receiving the at least one broadcast signal, to generate an emergency response request to the at least one particular emergency contact.

15. A non-transitory computer-readable medium having software instructions stored thereon, the software instructions configured to cause at least one processor device to perform steps comprising:
periodically transmitting, via at least one wireless communication radio of a smart device, a wireless advertisement comprising a wireless advertisement frame carrying data that identifies the smart device;
detecting, by the smart device, an actuation of a tactile trigger associated with the smart device;
automatically generating, by the smart device, an interrupt configured to cause the at least one wireless communication radio to cease periodically transmitting the wireless advertisement;
generating, by the smart device, at least one emergency alert packet carrying emergency alert data indicative of an occurrence of an emergency based on the actuation of the tactile trigger; and
transmitting, by the at least one wireless communication radio, at least one broadcast signal carrying the at least one emergency alert packet, wherein the at least one wireless communication radio is configured to retransmit the at least one broadcast signal a plurality of times at decreasing intervals between each time of the plurality of times.

16. The non-transitory computer-readable medium of claim 15, wherein the at least one emergency alert packet is configured to cause a primary device, upon receiving the at least one broadcast signal, to perform at least one of:
generate an audible siren indicative of the occurrence of the emergency to alert others within audible range, or
generate an emergency response request to an emergency response service, the emergency response request comprising data representing at least one of:
a current global positioning system (GPS) location of the primary device, or an altitude of the primary device.

17. The non-transitory computer-readable medium of claim 15, wherein the wireless advertisement comprises a wireless communication signal based on at least one of:
Bluetooth,
Bluetooth Low Energy,
Radio frequency identification (RFID), or
Near Field Communication (NFC).

18. The non-transitory computer-readable medium of claim 15, wherein the software instructions are further configured to cause at least one processor device to perform steps comprising:
receiving, by the smart device, at least one check-in signal carrying at least one check-in request; and
controlling, by the smart device, at least one component to emit a perceptible notification to a user associated with the smart device, the perceptible notification comprising at least one of an audible notification, or a haptic notification.

19. The non-transitory computer-readable medium of claim 18, wherein the software instructions are further configured to cause at least one processor device to perform steps comprising:
determining, by the smart device, a lack of a response user input via the tactile trigger within a predetermined period of time of emitting the perceptible notification; and
automatically generating, by the smart device, the interrupt.

20. The non-transitory computer-readable medium of claim 18, wherein the software instructions are further configured to cause at least one processor device to perform steps comprising:
determining, by the smart device, a response user input via the tactile trigger within a predetermined period of time of emitting the perceptible notification; and
controlling, by the smart device, the at least one wireless communication radio to continue to periodically transmit the wireless advertisement.
